(19) United States
(12) Patent Application Publication
(10) Pub. No.: US 2026/0254851 A1
(43) Pub. Date: Aug. 27, 2026

(54) MAINTAINING AUTHENTICITY IN THE METAVERSE

(71) Applicant: International Business Machines Corporation, Armonk, NY (US)

(72) Inventors: Guang Han Sui, Beijing (CN); Peng Hui Jiang, Beijing (CN); Jun Su, Beijing (CN); Yu Zhu, Beijing (CN); Jun Feng Duan, Beijing (CN)

(21) Appl. No.: 19/059,791

(22) Filed: Feb. 21, 2025

(51) Int. Cl. H04L 9/40; H04L 41/16

(52) U.S. Cl. CPC H04L 63/1483; H04L 41/16

(57) ABSTRACT

Techniques are described with respect to a system, method, and computer product for a method for optimizing security in a virtual environment. An associated method includes tracking a plurality of activities associated with at least one avatar of the virtual environment and determining a plurality of contextual information associated with the plurality of activities. The method further including analyzing the plurality of activities based on the plurality of contextual information to determine a theme associated with the virtual environment and classifying the plurality of activities based on the analysis and theme.

### BACKGROUND

This disclosure relates generally to computing systems and augmented reality, and more particularly to computing systems, computer-implemented methods, and computer program products configured to maintain authenticity in virtual environments.

The metaverse is a computer simulation of a virtual environment designed to allow users to traverse, inhabit, inhabit, and interact through the use of virtual avatars. The metaverse has adapted artificial intelligence mechanisms that enhance the metaverse experience; however, artificial intelligence mechanisms have also been applied to avatars in the form of chatbots, assisting agents, and the like.

### SUMMARY

Additional aspects and/or advantages will be set forth in part in the description which follows and, in part, will be apparent from the description, or may be learned by practice of the invention.

A system, method, and computer program product for optimizing security in a virtual environment, the method comprising: tracking a plurality of activities associated with at least one avatar of the virtual environment; determining a plurality of contextual information associated with the plurality of activities; analyzing the plurality of activities based on the plurality of contextual information to determine a theme associated with the virtual environment; and classifying the plurality of activities based on the analysis and theme.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual environment security optimization system environment, according to an exemplary embodiment;

FIG. 3 illustrates a block diagram of various modules associated with the virtual environment security optimization system of FIG. 2, according to an exemplary embodiment;

FIG. 4 illustrates a virtual environment depicting a plurality of activities performed by a metaverse user and an artificial intelligence (AI) agent, according to an exemplary embodiment;

FIG. 5 illustrates a prompt relating to authenticity of a given virtual avatar based on analyses of the plurality of activities, according to an exemplary embodiment; and

FIG. 6 illustrates an exemplary flowchart depicting a method for optimizing security in a virtual environment, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for optimizing security in a virtual environment. The metaverse comprises various virtual environments that support interactions between virtual avatars, virtual objects, and the like. However, the implementation of artificial intelligence/machine learning techniques in virtual/augmented/extended/mixed reality technology has resulted in various features such as virtual agents, virtual assistant, and the like into virtual environments. One of drawbacks of the aforementioned is that as AI becomes more intelligent, challenges as to knowing whether an action taken in the metaverse is performed by an avatar in response to a real person’s corresponding activities or by an avatar fully automated by AI present themselves. Thus, the present embodiments have the capacity to provide authenticity in the metaverse by analyzing actions of avatars in order to not only determine the identity/source of those actions, but also utilize machine learning in order to efficiently classify activities for the purpose of ascertaining one or more themes associated with given virtual environments.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein “artificial intelligence” refers to any applicable automated entity, agent, robot, dialogue/prompt, etc. including, but not limited to virtual agents, virtual assistants, robots, and any other applicable automated digital entity configured to interact with users known those of ordinary skill in the art.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

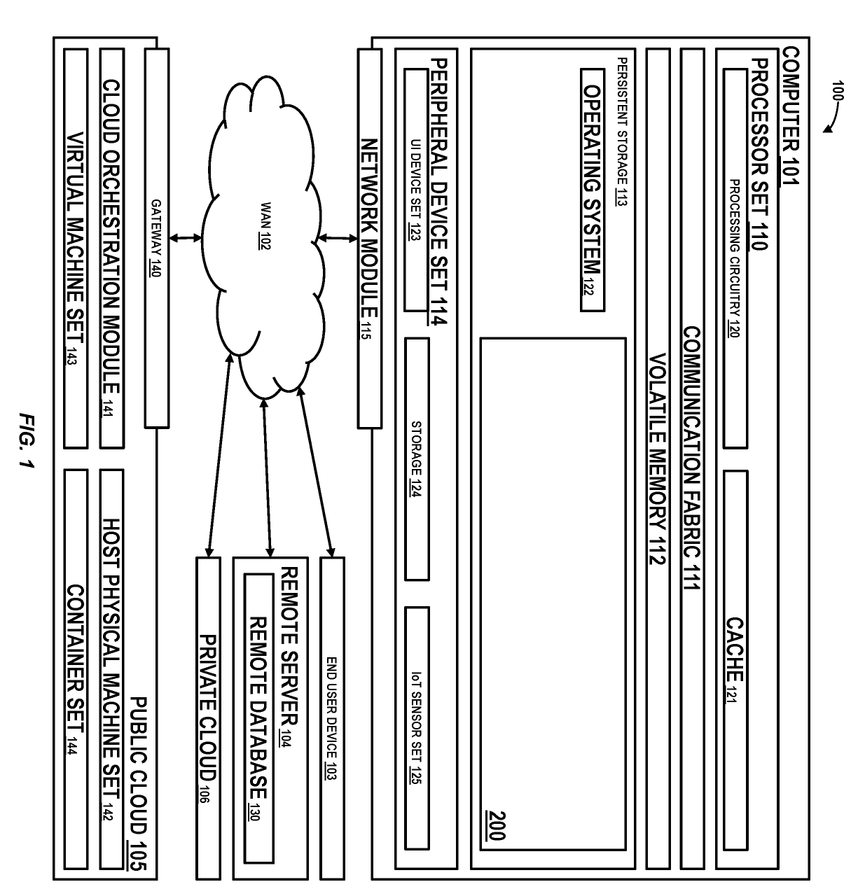

The following described exemplary embodiments provide a system, method, and computer program product for optimizing security in a virtual environment. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

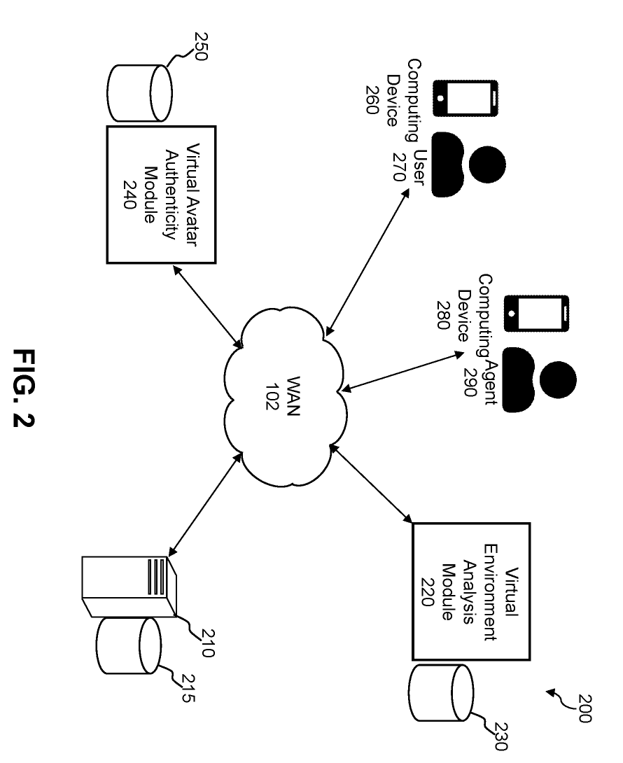

Referring now to FIG. 2, a functional block diagram of a networked computer environment illustrating a computing environment for a virtual environment security optimization system 200 (hereinafter “system”) comprising a server 210 communicatively coupled to a database 215, a virtual environment analysis module 220, a virtual environment analysis module database 230, a virtual avatar authenticity module 240, a virtual avatar authenticity module database 250, a computing device 260 associated with a user 270, and a computing device 280 associated with an agent 290, each of which are communicatively coupled over WAN 102 (hereinafter “network”) and data from the components of system 200 transmitted across the network is stored in database 215.

In some embodiments, server 210 is tasked with providing a centralized platform configured to analyze actions of avatars within a virtual environment in order to determine if the avatars are operated by a human user or artificial intelligence. It should be noted that continuous tracking and monitoring of actions of avatars and other applicable digital objects within a virtual environment allows system 200 to optimize authenticity and security of the virtual environment. For example, user 270 may participant in a virtual exhibition chess match in which the identity of their opponent may be unimportant; however, if it is a virtual championship chess match then the identity of the opponent would be relevant due to the stakes being higher. In some embodiments, contextual information associated with one or more of the avatars, activities, digital element/object, and virtual environment may be taken into consideration in order to determine the applicable source. For example, contextual information may be ascertained from analyses of user profiles, linguistics processing of dialogue between avatars, analyses of activities, related gestures of avatars, and the like. In some embodiments, server 210 may be communicatively coupled to one or more web crawlers configured to crawl applicable internet-based data sources in order to extract relevant data associated with user 270 including, but not limited to geographic location of user 270, internet browsing activity, and any other applicable ascertainable information known to those of ordinary skill in the art.

Virtual environment analysis module 220 is tasked with analyzing virtual environments and virtual elements within including, but not limited to avatars, chatbots, setting/theme, virtual objects, or any other applicable component associated with virtual spaces known to those of ordinary skill in the art. It should be noted that virtual environment analysis module 220 may utilize image/video analysis, parsing, tokenizing, 3D point cloud segmentation, virtual object detection, gesture analysis, theme identification, or any other applicable artificial intelligence-based and/or VR/AR-based analysis mechanisms known to those of ordinary skill in the art. In addition, virtual environment analysis module 220 may utilize natural language processing and other applicable cognitive-based techniques in order to process linguistic inputs associated with dialogues between avatars. Virtual environment analysis module 220 is further configured to analyze user profiles in order to ascertain relevant information associated with users operating the avatars. For example, virtual environment analysis module 220 analyzing a user profile associated with user 270 allows virtual environment analysis module 220 to ascertain information associated with user 270 such as, but not limited to user-specific patterns (e.g., schedule, routines, practices, etc.), user preferences, user geographic location, user gesture analytics (e.g., movements, range of motion, eye activity, etc), and the like. In some embodiments, virtual environment analysis module 220 is further configured to analyze biometrics, upon proper consent expressed by user 270, collected by one or more sensors associated with computing device 260. Data associated with computing device 260 and/or user 270 may be stored in user profiles housed in database 215, and various modules described herein may utilize one or more supervised and/or unsupervised learning techniques (e.g. feedback loops) processing datasets derived from database 215 in order to continuously optimize user preferences, configuration/design choices, user feedback, and the like and transmit results of the aforementioned to virtual avatar authenticity module 240 in order to optimize the user experience.

Virtual avatar authenticity module 240 is tasked with analyzing, scoring, and classifying activities associated with avatars within the applicable virtual environment. Furthermore, virtual avatar authenticity module 240 is configured to track and mark activities (and subsequent stages of the activities) of the avatars along with recording markings of the activities to a blockchain/distributed ledger stored on virtual avatar authenticity module database 250. This feature allows user 270 to be held accountable for results/consequences of the activities performed by the avatars by allowing user 270 and other applicable interested parties to view a log of the marked activities supported with timestamps and metadata related to the activities. For example, if an avatar is reviewing and signing a contract in the virtual environment, then the activity marking information needs to be stored through the blockchain/distributed ledger so that each activity and relevant subsequent activities ensure that the contract has been properly reviewed by the responsible parties. It should be noted that virtual avatar authenticity module 240 ensures that applicable activities are initially performed by user 270 and subsequent associated activities are performed by user 270 as well rather than agent 290; thus, ensuring authenticity of the given virtual environment. Furthermore upon applicable detection, analysis, scoring, and tracking of applicable activities, virtual avatar authenticity module 240 verifies the applicable activities and confirms the security of the applicable virtual environment and source of said activities (i.e., if the activities are being performed by user 270 or agent 290). For example, characteristics/attributes of user 270 and associated activities are stored in a blockchain, in which virtual avatar authenticity module 240 adds characteristics/attributes as a block to a blockchain, where the added block contains a cryptographic hash of the previous block, a timestamp, and data defining the relevant activities (e.g., user gestures, time, location, virtual environment setting, contextual information, etc.). It is here where a given activity may be disputed by user 270 and/or applicable party so that confidence to all parties involved that the activity is legitimate and not attributed to agent 290.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network, or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a LaDAR sensor, a LiDAR sensor, a temperature sensor, a humidity sensor, a motion sensor, internet-of-things (“IOT”) sensors, or any other applicable type of sensors known to those of ordinary skill in the art.

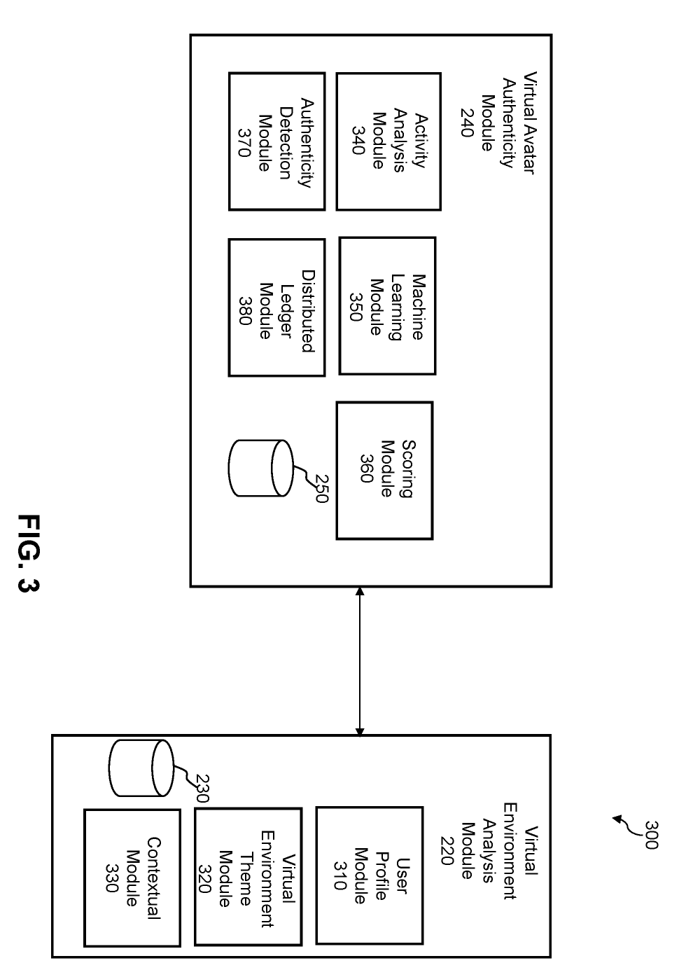

Referring now to FIG. 3, an example architecture 300 of virtual environment analysis module 220 and virtual avatar authenticity module 240 is depicted, according to an exemplary embodiment. In some embodiments, virtual environment analysis module 220 comprises user profile module 310, virtual environment theme module 320, and contextual module 330. Virtual avatar authenticity module 240 comprises activity analysis module 340, machine learning module 350, scoring module 360, authenticity verification module 370, and distributed ledger module 380. It should be noted that virtual environment analysis module 220 and virtual avatar authenticity module 240 are communicatively coupled over the network allowing for outputs and/or analyses performed by each respective module to be utilized in applicable training datasets to be utilized by applicable machine learning models operated by machine learning module 350 and/or applicable cognitive systems associated with system 200.

User profile module 310 is tasked with generating and maintaining user profiles associated with user 270 and any other applicable users operating on the centralized platform. It should be noted that the user profiles are utilized as a compilation of data of users within a virtual environment, in which various information relating to users including but not limited to user avatar behaviors, user preferences, interest, habits/routines, biological data subject to user authorization, user behavior data, user interaction data, user internet browsing-based data, social media-based data, and any other applicable user data known to those of ordinary skill in the art is continuously collected, analyzed, and updated. User profiles may also account for personal and/or sensitive data associated with user 270 subject to authorized consent such as but not limited to user’s calendar data, user disabilities, special accommodations, and the like.

Virtual environment theme module 320 is tasked with ascertaining one or more themes associated with a given virtual environment and/or avatar. In some embodiments, virtual environment theme module 320 utilizes one or more techniques to analyze virtual environments including, but not limited to, natural language processing (NLP), image analysis, topic identification, virtual object recognition, setting/environment classification, and any other applicable artificial intelligence and/or cognitive-based techniques known to those of ordinary skill in the art. Virtual environment theme module 320 is further tasked with providing techniques that facilitate automatic, reliable performance of a point cloud object-environment segmentation task in order to analyze virtual environments. For example, virtual environment theme module 320 may provide the capability to perform automatic segmentation of a 3D point cloud into object and virtual environment segments by progressively learning the object-environment segmentation from tracking sessions in VR/AR applications. In some embodiments, virtual environment theme module 320 ascertains one or more themes associated with a given virtual environment by utilizes the aforementioned techniques to dialogues, virtual elements/objects, avatars gestures/actions, and the like within the virtual environment. For example, virtual environment theme module 320 may analyze virtual elements within a given virtual environment such as number of avatars, movements of the avatars, dialogues of the avatars, and other virtual elements in order to determine that the venue of the virtual environment is an E-sport arena and the theme of the virtual environment is a championship match being held within the E-sport arena. Furthermore, one or more themes may be determined for actions performed by avatars in order to assist determination of whether a given avatar is operated by user 270 or agent 290. For example, slower detected leg movements of an avatar at a particular pace with a detected lower heartrate, relaxed facial movements, etc. indicate that the avatar is on a peaceful walk in the virtual environment as opposed to faster detected leg movements, higher heartrate, strenuous facial movements, etc. indicate the avatar is running the in the virtual environment. In another example, particular dialogues between an avatar and other avatars at a particular time may allow virtual environment theme module 320 to determine the theme of a virtual meeting occurring within the virtual environment. It should be noted that detecting theme, venue, etc. associated with a given virtual environment assists contextual module 330 with establishing contextual information associated with the virtual environment along with assist with identification of abnormal activity associated with user 270 (e.g., avatar associated with user 270 navigating a virtual environment they have not explored in the past, etc.).

Contextual module 330 is tasked with ascertaining contextual information associated with a virtual environment and the activities associated with avatars within the virtual environment. In some embodiments, contextual module 330 analyzes virtual environment elements (e.g., setting, theme, virtual objects, etc.), dialogue/topic/presenters associated with virtual collaborations occurring within the virtual environment, social media network information, news/politics, weather, and any other applicable information relevant to the geographic location or virtual environment location of the user 270 known to those of ordinary skill in the art. As described herein, contextual information may include, but is not limited to, relevant information associated with the geographic location of user 270 (e.g., weather, traffic, politics, laws/ordinances, etc.), topic/subject matter, date/time of day, environment/virtual object theme/setting, habits/routines, preferences, participant dialogue concept, an event within the virtual environment (e.g., E-sport, dining experience, E-concert, shopping experience, etc.), occurrences of a predetermined pattern of user 270, agent 290, or activities thereof within the virtual environment, or any other applicable contextual-based data known to those of ordinary skill in the art. It should be noted that ascertaining contextual information is imperative for virtual avatar authenticity module 240 to detect abnormal activities that require confirmation from user 270. For example, if the avatar associated with user 270 is detected signing a contract within a given virtual environment, and the ascertained contextual information establishes that the time of day that the aforementioned activity is occurring is abnormal then this activity will be flagged for review/authorization by user 270.

Activity analysis module 340 is tasked with analyzing one or more activities associated with avatars occupying a given virtual environment. It should be noted that a virtual interaction is a virtual activity and/or movement performed by user 270 or agent 290 in the virtual environment which may include, but is not limited to communicating with other avatars/virtual objects, virtual meetings/multi-party discussions, virtually socializing, taking examinations, exercising, or any other applicable virtual activities known to those of ordinary skill in the art. Activity analysis module 340 may utilize image/video analysis, parsing, tokenizing, 3D point cloud segmentation, virtual object detection, gesture analysis, theme identification, or any other applicable artificial intelligence-based and/or VR/AR-based analysis mechanisms known to those of ordinary skill in the art. Activity analysis module 340 analyzes activities based on various factors such as but not limited to user profile, contextual information, identified virtual environment theme, and the like in order for activity analysis module 340 to classify activities and sub-activities performed by avatars and ultimately store them in a distributed ledger. In addition to activity analysis module 340 analyzing activities of avatars, activity analysis module 340 also extracts metadata associated with the activities for storage in a blockchain, in which the activity metadata may include but is not limited to time of the activity, position/location within the virtual environment the activity occurs, context associated with the activity, theme/venue of the given virtual environment the activity is occurring within, level of importance of the activity, whether the activity aligns with the user profile and/or routines/habits of user 270, and the like.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 350 is designed to maintain one or more machine learning models dealing with training datasets including data derived from database 215, virtual environment analysis module database 230, and a virtual avatar authenticity module database 250, in which the one or more machine learning models generate outputs representing predictions relating to contextual information, activities/classification, activity marking, activity scores, whether user 270 or agent 290 is performing an activity, and the like. In some embodiments, machine learning module 350 is utilized to perform classification of activities in order for system 200 to generate and continuously update a predefined library of activities stored in database 215. The classifications are ascertained by utilizing one or more machine learning models to determine the predefined activities based on one or more of contextual information, previously detected activities, themes, and the like.

Scoring module 360 is tasked with scoring and prioritizing activities performed by avatars in a given virtual environment. It should be noted that activities may be scored based on various factors including but not limited to contextual information, analyses of user profiles, ascertained theme of the given virtual environment, and the like. Furthermore, scoring module 360 is designed to determine whether a given activity needs to be marked in order for authenticity verification module 370 to ultimately determine whether the activity is being performed by user 270 or agent 290. In some embodiments, scoring module 360 assigns a score to an activity indicative of the severity or level of importance on the activity. For example, an avatar signing a contract in a given virtual environment would comprise a higher score than the avatar browsing a virtual marketplace, or the avatar engaging in dialogue in a virtual collaboration would comprise in a higher score than the avatar participating in an E-sport event. In some embodiments, scoring module 360 analyzes and scores sub-activities derived from activities, in which the sub-activities may be subsequent events associated with initial activities occurring across various time slots, and activity metadata of the sub-activities assist with authenticity detection module 370 determining whether an activity is being performed by user 270 or agent 290. For example, if an avatar begins a process in the virtual environment in a manner that reflects the routines/historical patterns of user 270, but subsequent sub-activities are occurring in an abnormal context, theme, venue, etc. then the scoring of the sub-activities adjusts accordingly and user 270 is prompted to intervene/confirm. In some embodiments, scoring module 360 is further configured to separate the avatar’s activities and sub-activities into different time slots in order to identify a theme for each time slot and ultimately combine the theme for consecutive time slots if necessary.

Authenticity verification module 370 is tasked with determining if an activity or sub-activity associated with an avatar is being performed by user 270 or agent 290. It should be noted that authenticity verification module 370 communicates with machine learning module 350 in order to ascertain whether a given activity is performed by user 270 or agent 290, in which activities and sub-activities associated with an avatar are compressed and synthesized with a Generative Adversarial Network (GAN) for subsequent use by various modules. The vectors may comprise activity metadata (e.g., temporal data, timestamps, discussed topics, etc.). The aforementioned assists with authenticity verification module 370 tracking and marking activities (and subsequent stages of the activities) of the avatars along with instructing distributed ledger module 380 to record markings of the activities to a blockchain/distributed ledger stored on virtual avatar authenticity module database 250. In some embodiments, upon detecting abnormal activity and/or sub-activities authenticity verification module 370 generates prompts presented to user 270 in order to verify that the abnormal activity and/or sub-activities at issue was in fact being performed by user 270 rather agent 290, in which the source of the avatar may be confirmed by one or more of user 270 answering prompts via linguistic inputs, gestures, biometrics/liveness data, and the like. In some embodiments, each response to an applicable prompt is recorded to the respective block of the distributed ledger associated with the respective activity in order to create of log of activities associated with an avatar for viewing by user 270 and/or the applicable qualified third-party. For example, if one or more sub-activities associated with an initial avatar activity of signing a contract in a given virtual environment are marked as abnormal based on one or more of contextual information, theme, venue, dialogue, and the like then a log of the prompts, responses to the prompts, and other applicable metadata will be accessible by applicable parties of the contract in order to ensure security and that agent 290 did not enter into the contract on behalf of user 270.

Distributed ledger module 380 is designed to record and maintain activities, sub-activities, and applicable metadata to blockchains, in which this information and/or metadata may be output to the user devices associated with the users. In some embodiments, markings and recording may be accomplished by signatures recorded to a blockchain in order to provide an immutable and third-party verifiable proof of the activities and/or sub-activities along with their applicable authorization that occurred within a given virtual environment. In some embodiments, authenticity verification module 370 utilizes the blockchain associated with an avatar’s activity to determine whether the same avatar may access the functionality to accomplish the sub-activities and/or control the avatar altogether. For example, if authenticity verification module 370 determines that the avatar source is agent 290, then authenticity verification module 370 may cease functionality of the avatar altogether.

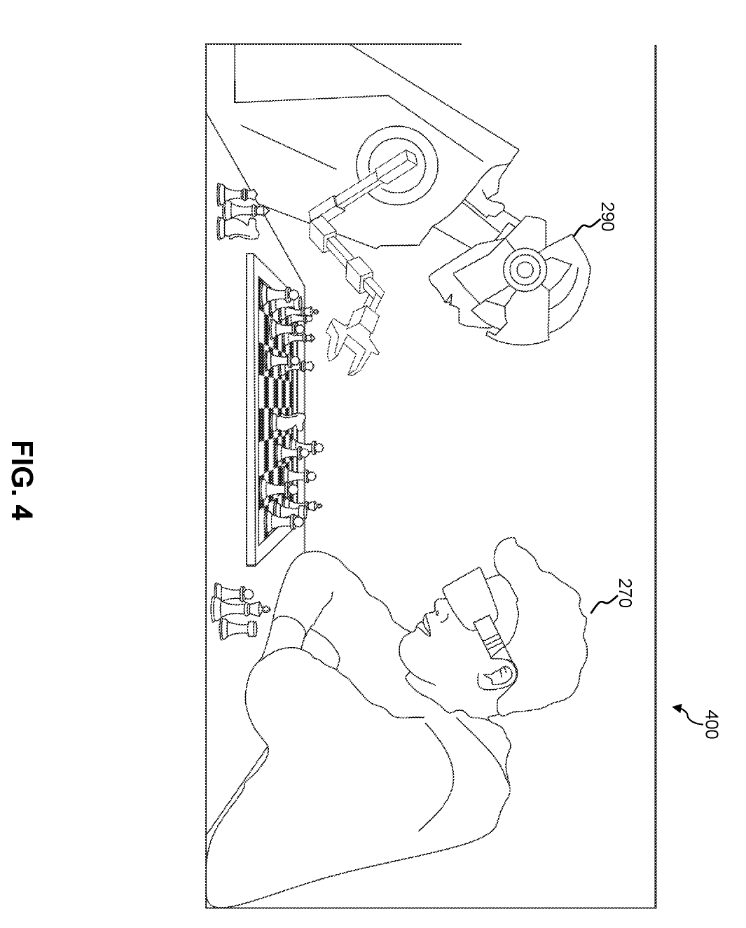

Referring to FIG. 4, a virtual environment 400 depicting various activities performed by user 270 and artificial intelligence (AI) agent 290, is depicted according to an exemplary embodiment. In particular, avatars respectively representing user 270 and agent 290 in virtual environment 400 are engaged in the activity of a chess match, in which each activity of the user 270 and agent 290 (e.g., chess moves, dialogue, gestures, etc.) are sub-activities tracked, monitored, and subsequently stored on distributed ledgers. For example, user 270 may not be aware that agent 290 is controlling the opponent avatar, in which each of the activities and/or sub-activities performed by the opponent avatar are tracked, marked, scored, and stored to a distributed ledger resulting in a log accessible by applicable parties. This allows authenticity verification module 370 to ascertain not only whether the opponent avatar currently being controlled by agent 290 we previously controlled by an actual user (e.g., detection of activities routine based on user profile analyses, captured biometrics, liveness data detection, etc.), but also at what point during the chess match and/or tournament agent 290 began controlling the opponent avatar. As previously mentioned, the determination as to whether the opponent avatar is being controlled by agent 290 may be based on one or more of analyses of applicable user profiles, contextual information, virtual environment theme, virtual environment venue, the time of day, the physical location of the intended user controlling the opponent avatar, and the like.

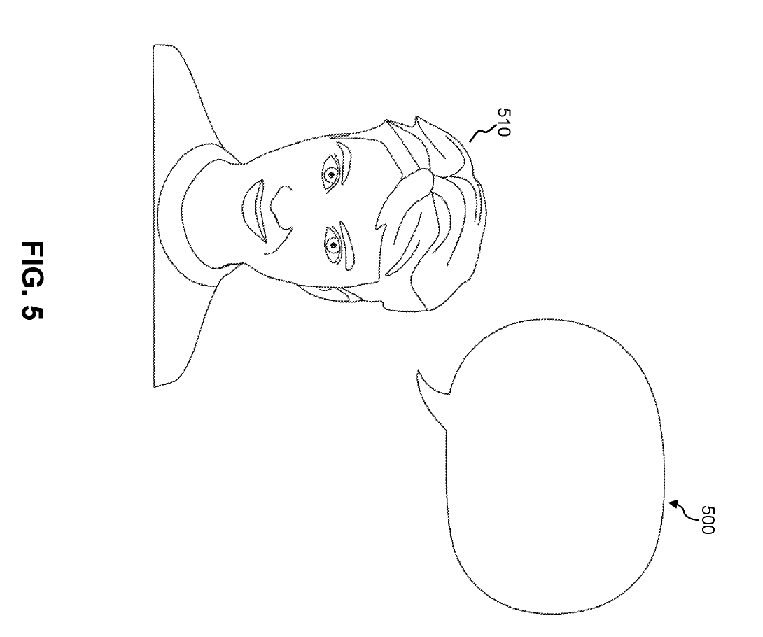

Referring to FIG. 5, a virtual environment-based prompt 500 relating to confirming authenticity of activities of a given virtual avatar 510 is depicted, according to an exemplary embodiment. As depicted, prompt 500 is generated based on analyses of one or more activities of virtual avatar 510 triggering an alert indicating that abnormal activity is occurring that does not align with the routines, habits, dialogues, gestures, etc. associated with user 270; thus, virtual avatar authenticity module 240 seeks to not only inform user 270 about the abnormality of the activities performed by virtual avatar 510, but also obtain confirmation that user 270 is in control of virtual avatar 510. In some embodiments, a detected abnormal and/or unconventional virtual environment theme, venue, or context may trigger prompt 500 to be presented to user 270. User 270 may respond/confirm control of the activities associated with virtual avatar 510 by providing one or more textual responses, voice-responses, gestures, virtual object interactions, liveness data, or any other applicable virtual/augmented reality-based responses known to those of ordinary skill in the art. In some embodiments, the activities and sub-activities are subsequently prevented based on a lack of confirmation or a particular classification that actions are being performed by agent 290. The confirmation of user 270 is saved as a signature for each activity on each applicable block of the distributed ledger; therefore, allowing each confirmation at each block to be visible by the applicable party via the log.

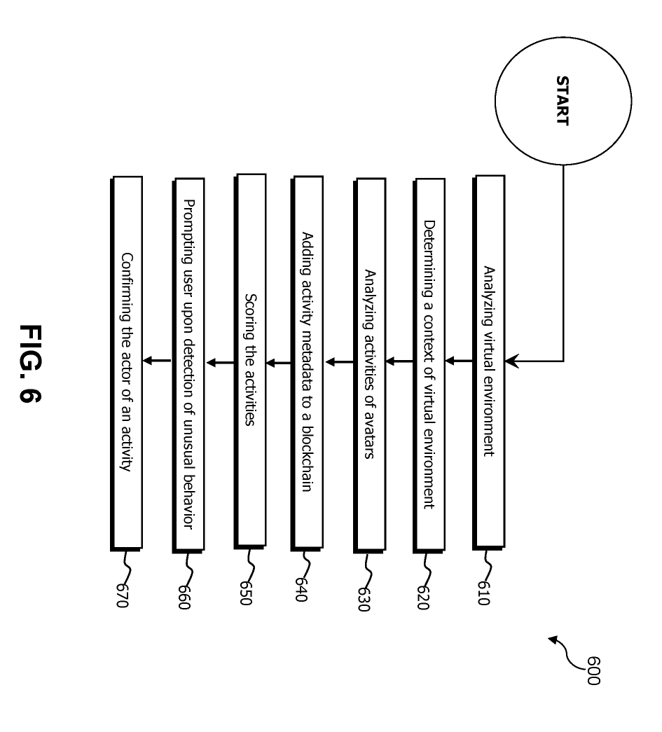

With the foregoing overview of the example architecture, it may be helpful now to consider a high-level discussion of an example process. FIG. 6 depicts a flowchart illustrating a computer-implemented process 600 for optimizing security in a virtual environment, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, virtual environment analysis module 220 analyzes a given virtual environment. Virtual environment analysis module 220 may communicate with machine learning module 350 in order to utilize one or more convolution neural networks (CNNs) and/or other applicable machine learning models in order to perform virtual object detection/analyses, virtual environment theme detection, contextual information retrieval, virtual venue/event type recognition, and the like. In particular, virtual environment analysis module 220 ascertains the aforementioned in order to obtain relevant information associated with avatars occupying the given virtual environment.

At step 620 of process 600, contextual module 330 determines context associated with the given virtual environment. As previously mentioned, contextual module 330 is tasked with ascertaining contextual information associated with a virtual environment and the activities associated with avatars within the virtual environment. In some embodiments, contextual module 330 analyzes virtual environment elements (e.g., setting, theme, virtual objects, etc.), dialogue/topic/presenters associated with virtual collaborations occurring within the virtual environment, social media network information, news/politics, weather, and any other applicable information relevant to the geographic location or virtual environment location of the user 270 known to those of ordinary skill in the art. It should be noted that ascertaining context of a given virtual environment supports not only the scoring of an activity because of the applicable priority associated with the activity, but also the classification of the theme and relevant metadata associated with detected avatar activities/sub-activities. For example, it is determined that the theme and context associated with an avatar indicates the avatar is a spectator of an E-sport event meaning that the priority/severity of the activity low, and an appropriate score is assigned accordingly.

At step 630 of process 600, activity analysis module 340 analyzes the activities/sub-activities of avatars within the given virtual environment. Activity analysis module 340 utilizes image/video analysis, parsing, tokenizing, 3D point cloud segmentation, virtual object detection, gesture detection/analysis, theme identification, user profile analyses, and the like in order to not only classify/label avatar activities, but also track and monitor activities for the purpose of identifying abnormal activities associated with user 270 compared to historical patterns, trends, routines, etc. For example, if an avatar ordinarily controlled by user 270 typically goes to sleep at a particular time, and the avatar is detect perform one or more activities/sub-activities significantly past that particular time then abnormal activity and/or theme may be detected triggering activity analysis module 340 to track/monitor sub-activities. In some embodiments, activity analysis module 340 differentiates activities based on a plurality of detected time slot.

At step 640 of process 600, distributed ledger module 380 adds the activities and/or sub-activities to blocks of a blockchain. It should be noted that the activities and their respective metadata are added to the blockchain not only for tracking/monitoring purposes, but also to support time-series based analyses of the activities so they can be compared to historical patterns, trends, etc. associated with avatars previously operated by user 270. Additionally, confirmations provided by user 270 in response to prompts triggered by detected abnormal activities/sub-activities are saved as signatures to the respective blocks of the blockchains allowing a log of activity confirmations to be viewed by user 270 or applicable third parties. In some embodiments, a lack of confirmation of an activity or sub-activity may result in functionality of the avatar being terminated altogether due to the fact that it indicates that user 270 is in fact not currently operating the applicable avatar.

At step 650 of process 600, scoring module 360 assigns a score to each of the activities and/or sub-activities. In some embodiments, themes associated with activities and sub-activities may be scored also, in which the scoring is an indicator of priority or severity of the activity. As previously mentioned, activities may be scored based on various factors including but not limited to contextual information, analyses of user profiles, ascertained theme of the given virtual environment, and the like. For example a championship match of a virtual competition would be assigned a higher score than an exhibition match due to the fact that the stakes and impact resulting from agent 290 being a competitor would be greater (i.e., championship reward being won by agent 290). In another example, an avatar reviewing/signing a contract in a virtual environment would have a higher score than the avatar playing games with friends. In some embodiments, scoring module 360 is further configured to separate the avatar’s activities and sub-activities into different time slots in order to identify a theme for each time slot and ultimately combine the theme for consecutive time slots if necessary. For example, at a first time interval user 270 is reviewing a contract for signing in which the theme is contract reviewing and at a second time interval user 270 receives an instant message from a friend and proceeds to chat with the friend, which interrupts the contract signing process; thus, the interaction with the friend is the theme. Subsequently at a third time interval user 270 returns to contract reviewing and the indicated theme is contract reviewing.

At step 660 of process 600, authenticity verification module 370 generates prompts presented to user 270 based on detected unusual behavior. It should be noted that authenticity verification module 370 generates prompts for user 270 as to whether the activities are those of user 270 based on analyses of avatar activities indicating abnormal activity, in which the abnormal activity is detected based on comparison of the current activity and/or sub-activities to historical patterns, trends, gestures, behavior, etc. associated with user 270 derived from analyses of the applicable user profile.

At step 670 of process 600, authenticity verification module 370 confirms the source associated with the activities being performed by the applicable avatar. It should be noted that verification of the source of the activities indicates that the activities are being performed by user 270 or agent 290. In some embodiments, if authenticity verification module 370 determines that the activities of avatar are being controlled/performed by agent 290 then authenticity verification module 370 may terminate functionality of the applicable avatar altogether.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms "a," "an," and "the" are intended to include the plural forms as well, unless the context clearly indicates otherwise. It will be further understood that the terms "comprises," "comprising," "includes," "including," "has," "have," "having," "with," and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for optimizing security in a virtual environment, the method comprising:
tracking, by a computing device, a plurality of activities associated with at least one avatar of the virtual environment;
determining, by the computing device, a plurality of contextual information associated with the plurality of activities;
analyzing, by the computing device, the plurality of activities based on the plurality of contextual information to determine a theme associated with the virtual environment; and
classifying, by the computing device, the plurality of activities based on the analysis and theme.

2. The computer-implemented method of claim 1, wherein classifying the plurality of activities indicates whether the plurality of activities are performed by a user or artificial intelligence (AI).

3. The computer-implemented method of claim 1, wherein classifying the plurality of activities comprises:
determining, by the computing device, a plurality of sub-activities associated with the plurality of activities; and
storing, by the computing device, a plurality of classifications applied to the plurality of activities and sub-activities in a distributed ledger.

4. The computer-implemented method of claim 1 further comprising:
preventing, by the computing device, one or more of the plurality of activities associated with the at least one avatar based on the classification;
wherein the classification indicates the at least one avatar is controlled by either a real person or AI.

5. The computer-implemented method of claim 1, wherein analyzing the plurality of activities comprises:
differentiating, by the computing device, the plurality of activities based on a plurality of detected time slot; and
determining, by the computing device, the theme for each activity of the plurality of activities at each time slot.

6. The computer-implemented method of claim 1, wherein classifying the plurality of activities comprises:
generating, by the computing device, a score for the theme;
wherein the score indicates a level of importance of the activity of the plurality of activities associated with the theme.

7. The computer-implemented method of claim 1, wherein the classification is derived from a predefined library of activities ascertained by utilizing one or more machine learning models to determine the predefined activities based on the plurality of contextual information.

8. A computer program product for optimizing security in a virtual environment, the computer program product comprising or more computer readable storage media and program instructions collectively stored on the one or more computer readable storage media, the stored program instructions comprising:
program instructions to track a plurality of activities associated with at least one avatar of the virtual environment;
program instructions to determine a plurality of contextual information associated with the plurality of activities;
program instructions to analyze the plurality of activities based on the plurality of contextual information to determine a theme associated with the virtual environment; and
program instructions to classify the plurality of activities based on the analysis and theme.

9. The computer program product of claim 8, wherein program instructions to classify the plurality of activities comprise:
program instructions to determine a plurality of sub-activities associated with the plurality of activities; and
program instructions to store a plurality of classifications applied to the plurality of activities and sub-activities in a distributed ledger.

10. The computer program product of claim 8 further comprising:
program instructions to prevent one or more of the plurality of activities associated with the at least one avatar based on the classification;
wherein the classification indicates the at least one avatar is controlled by either a real person or AI.

11. The computer program product of claim 8, wherein program instructions to classify the plurality of activities indicates whether the plurality of activities are performed by a user or artificial intelligence (AI).

12. The computer program product of claim 8, wherein program instructions to analyze the plurality of activities comprise:
program instructions to differentiate the plurality of activities based on a plurality of detected time slot; and
program instructions to determine the theme for each activity of the plurality of activities at each time slot.

13. The computer program product of claim 8, wherein program instructions to classify the plurality of activities comprise:
program instructions to generate a score for the theme;
wherein the score indicates a level of importance of the activity of the plurality of activities associated with the theme.

14. The computer program product of claim 8, wherein the classification is derived from a predefined library of activities ascertained by utilizing one or more machine learning models to determine the predefined activities based on the plurality of contextual information.

15. A computer system for optimizing security in a virtual environment, the computer system comprising:
one or more processors;
one or more computer-readable memories;
program instructions stored on at least one of the one or more computer-readable memories for execution by at least one of the one or more processors, the program instructions comprising:
program instructions to track a plurality of activities associated with at least one avatar of the virtual environment;
program instructions to determine a plurality of contextual information associated with the plurality of activities;
program instructions to analyze the plurality of activities based on the plurality of contextual information to determine a theme associated with the virtual environment; and
program instructions to classify the plurality of activities based on the analysis and theme.

16. The computer system of claim 15, wherein program instructions to classify the plurality of activities comprise:
program instructions to determine a plurality of sub-activities associated with the plurality of activities; and
program instructions to store a plurality of classifications applied to the plurality of activities and sub-activities in a distributed ledger.

17. The computer system of claim 15 further comprising:
program instructions to prevent one or more of the plurality of activities associated with the at least one avatar based on the classification;
wherein the classification indicates the at least one avatar is controlled by either a real person or AI.

18. The computer system of claim 15, wherein program instructions to classify the plurality of activities indicates whether the plurality of activities are performed by a user or artificial intelligence (AI).

19. The computer system of claim 15, wherein program instructions to analyze the plurality of activities comprise:
program instructions to differentiate the plurality of activities based on a plurality of detected time slot; and
program instructions to determine the theme for each activity of the plurality of activities at each time slot.

20. The computer system of claim 15, wherein program instructions to classify the plurality of activities comprise:
program instructions to generate a score for the theme;
wherein the score indicates a level of importance of the activity of the plurality of activities associated with the theme.
